(19) United States
(12) Patent Application Publication
(10) Pub. No.: US 2021/0225305 A1
(43) Pub. Date: Jul. 22, 2021

(54) DISPLAY DEVICE

(71) Applicant: NEC Display Solutions, Ltd., Tokyo (JP)

(72) Inventor: Shinya NIIOKA, Tokyo (JP)

(21) Appl. No.: 17/051,595

(22) PCT Filed: May 21, 2018
(86) PCT No.: PCT/JP2018/019464

§ 371 Date: Oct. 29, 2020

(51) Int. Cl. G09G 3/36; G06F 3/01

(52) U.S. Cl. CPC G09G 3/3607; G06F 3/013; G09G 2320/0666; G09G 2320/0261; G09G 2300/026; G09G 2340/045; G09G 2330/023; G09G 2320/0686

(57) ABSTRACT

The present invention includes: a display unit that displays an image; a detection unit that detects a line of sight and a position of a viewer viewing the display unit; and a control unit that selects, based on information about the position of the viewer detected by the detection unit, a color gamut according to a position of a display region of the display unit, and displays the image in the selected color gamut on the display unit.

### TECHNICAL FIELD

The present invention relates to a display device.

### BACKGROUND ART

In the field of display devices, a reduction in the power consumption is being sought while progress has been made in increasing the size, definition, and color gamut of display panels. For example, Patent Document 1 discloses a technique that improves the image quality of a liquid crystal display device including a liquid crystal display panel, while also reducing the power consumption. In the technique disclosed in Patent Document 1, as shown in FIG. 6 of Patent Document 1, a TFT (Thin-Film Transistor) serving as a thin-film transistor of the liquid crystal display panel is arranged in a staggered structure.

In this technique, a DC (Direct Current) waveform signal equivalent to a conventional column inversion method is supplied from a data driver. Because the TFT is arranged in a staggered structure, it is possible to generate a display with a dot inversion method, which has a higher image quality than the column inversion method. In addition, in this technique, because the signal provided by the data driver has a DC waveform, it is possible to drive with a lower power consumption compared to the conventional dot inversion method.

When a color display is generated using a liquid crystal display panel having the configuration described in Patent Document 1, the configuration of the display device includes, for example, as shown in FIG. 29, a color filter in a striped configuration, that is to say, in an arrangement in which red (R), green (G), and blue (B) are repeated in this order.

In FIG. 29, the reference symbol of each pixel electrode PXL of the liquid crystal display panel 1001 is a reference symbol that combines the row number and the column number, and, for example, the pixel electrode PXL1-2 is the pixel electrode located in the first row and the second column, and, the thin-film transistor corresponding to the pixel electrode PXL1-2 is similarly assigned a reference symbol that combines the row number and the column number and is depicted as the thin-film transistor TFT1-2. In FIG. 29, reference symbols have only been assigned to the pixel electrodes PXL1-1 to PXL1-7 and the thin-film transistors TFT1-1 to TFT1-7; however, it is assumed that reference symbols are similarly assigned to the second and subsequent rows.

In FIG. 29, the red pixel electrodes are the first column of pixel electrodes PXL1-1, PXL2-1, . . . , the fourth column of pixel electrodes PXL1-4, PXL2-4, . . . , the seventh column of pixel electrodes PXL1-7, PXL2-7, . . . , and so on. Similarly, the green pixel electrodes are the second column, the fifth column, the eighth column, and so on, and the blue pixel electrodes are the third column, the sixth column, the ninth column, and so on.

When a monochrome display having a white or gray pattern is performed in a liquid crystal display panel capable of such a color display, the red, green and blue colors are emitted at the same brightness level. Therefore, for example, the voltage waveform supplied from the data driver 1003 to the data lines DL4 and DL5 is the DC waveform shown in FIG. 30, which has an inverted polarity.

In contrast, in the case where a color display is performed, when only a red color is displayed as shown in FIG. 31A for example, the red pixel electrodes of the first column pixel electrodes PXL1-1, PXL2-1, . . . , the fourth column pixel electrodes PXL1-4, PXL2-4, . . . , the seventh column pixel electrodes PXL1-7, PXL2-7, . . . , and so on, are the only pixels made to emit light. In this case, for example, the voltage waveform supplied from the data driver 1003 to the data lines DL4 and DL5 is the rectangular wave shown in FIG. 31B, which prevents green and blue light from being emitted.

When such a rectangular wave is generated at high frequencies in the timing control unit 1002, the power consumption increases compared to a case where a DC waveform is generated. Therefore, in display devices that are capable of performing a color display, the power consumption is higher when a color display is performed than when a monochrome display is performed.

As mentioned above, in recent years, there is demand for display devices which include a liquid crystal display panel that, rather than simply performing a color display, display images in a wider color gamut. When an image is displayed in a wide color gamut, it is necessary to increase the density of the color filter of the liquid crystal; however, the brightness decreases when the density of the color filter is increased.

Therefore, in order to perform a display in a wide color gamut with a permissible brightness, the output of the light source is increased to increase the brightness level. As a result, a wider color gamut increases the power consumption of the display device.

Further, in recent years, there is demand for an increase in the size (for example, 55 inches or more) and definition (for example, 4K, 8K or higher) of display panels in display devices. It is known that the amount of power used to write data to each pixel included in the display panel, that is to say, the amount of power used to charge each pixel, is an amount that increases based not on the inch-size, but on a squared area ratio. Therefore, an increase in size leads to a sharp increase in the power consumption. Moreover, when the definition is increased, the frame rate becomes higher (for example, 120 Hz or higher), and thus the drive frequency required for scanning becomes higher, which increases the power consumption.

In addition, by increasing the frame rate, the horizontal period for charging a pixel, that is to say, the pixel selection period, becomes shorter; therefore, it becomes impossible to sufficiently charge the pixel due to limitations in the driving capability of the TFT. When sufficient charging cannot be performed and the pixel becomes insufficiently charged, the brightness decreases, and, in order to supply power to compensate for this, the power consumption increases.

### PRIOR ART DOCUMENTS

### Patent Documents

[Patent Document 1] Japanese Unexamined Patent Application, First Publication No. 2007-249240

[Patent Document 2] Japanese Unexamined Patent Application, First Publication No. 2001-228848

[Patent Document 3] Japanese Unexamined Patent Application, First Publication No. 2016-184058

### SUMMARY OF THE INVENTION

### Problem to be Solved by the Invention

In display devices which include a striped color filter and are capable of performing a color display by the dot inversion method, for example, as mentioned above using the technique described in Patent Document 1 as an example, a high-frequency rectangular wave is applied in the vertical direction. When the screen size and definition of the display panel is increased in such a display device, the influence of the limitations in the TFT driving capability appear not only in the horizontal direction, but also in the vertical direction. Therefore, as a result of the increase in screen size and definition, there is a problem that a significant difference emerges between the power consumption when a color display is performed, and the power consumption when a monochrome display is performed.

In a display device, the entire screen is displayed in the same color gamut. However, it is known that the region gazed at by a viewer viewing the screen is a partial region of the screen. Therefore, if it is possible to change the color gamut according to whether or not a viewer is gazing, that is to say, the viewing state of a viewer, and to display the image such that positions that are not gazed at by the viewer are displayed in a color gamut having a lower power consumption, it becomes possible to reduce the power consumption. However, in techniques that change a display state according to a viewing state of a viewer (for example, see Patent Documents 2 and 3), a solution that reduces the power consumption by displaying the image in a different color gamut is not described.

The present invention has been made in order to solve the problems described above, and an object thereof is to provide a display device and a display method that reduce power consumption by displaying an image in an appropriate color gamut according to a viewing state of a viewer.

### Means for Solving the Problem

The present invention is a display device including: a display unit that displays an image; a detection unit that detects a line of sight and a position of a viewer viewing the display unit; and a control unit that selects, based on information about the position of the viewer detected by the detection unit, a color gamut according to a position of a display region of the display unit, and displays the image in the selected color gamut on the display unit.

### Effect of the Invention

According to the present invention, it is possible to reduce power consumption by displaying an image in an appropriate color gamut according to a viewing state of a viewer.

### BRIEF DESCRIPTION OF THE DRAWINGS

FIG. 1 is a block diagram showing the configuration of a display device according to a first example embodiment.

FIG. 2 is a block diagram showing the configuration of a display device according to a second example embodiment.

FIG. 3 is a diagram showing an outer appearance of the display device of the same example embodiment.

FIG. 4 is a diagram showing the configuration of a display unit of the display device of the same example embodiment.

FIG. 5 is a flowchart showing the flow of processing performed by a detection unit of the same example embodiment.

FIG. 6 is a flowchart showing the flow of processing performed by a control unit of the same example embodiment.

FIG. 7 is a diagram (part 1) that describes a viewing region in the same example embodiment.

FIG. 8 is a diagram (part 2) that describes the viewing region in the same example embodiment.

FIG. 9 is a diagram (part 1) showing a first additional configuration example of the same example embodiment.

FIG. 10 is a diagram (part 2) showing the first additional configuration example of the same example embodiment.

FIG. 11 is a diagram (part 1) showing a second additional configuration example of the same example embodiment.

FIG. 12 is a diagram (part 2) showing the second additional configuration example of the same example embodiment.

FIG. 13 is a block diagram showing the configuration of a display device according to a third example embodiment.

FIG. 14 is a diagram showing an outer appearance of the display device of the same example embodiment.

FIG. 15 is a diagram (part 1) showing the configuration of a display panel of the same example embodiment.

FIG. 16 is a diagram (part 2) showing the configuration of the display panel of the same example embodiment.

FIG. 17A is a diagram that describes a calculation method of a visible region in the same example embodiment.

FIG. 17B is a diagram that describes a calculation method of the visible region in the same example embodiment.

FIG. 18A is a diagram showing the relationship between the distance to a viewer, a viewing width, and a visible region in the same example embodiment.

FIG. 18B is a diagram showing the relationship between the distance to a viewer, a viewing width, and a visible region in the same example embodiment.

FIG. 19 is a diagram that describes a calculation method of a viewing region in the same example embodiment.

FIG. 20 is a diagram that describes a merging method of a visible region and a viewing region in the same example embodiment.

FIG. 21 is a flowchart showing the flow of processing performed by a control unit of the same example embodiment.

FIG. 22 is a diagram showing a first additional configuration example of the same example embodiment.

FIG. 23A is a diagram showing a second additional configuration example of the same example embodiment.

FIG. 23B is a diagram showing a second additional configuration example of the same example embodiment.

FIG. 24 is a block diagram showing the configuration of a display device according to a fourth example embodiment.

FIG. 25 is a diagram (part 1) showing an outer appearance and a cross-section of the display device of the same example embodiment.

FIG. 26 is a diagram (part 2) showing an outer appearance and a cross-section of the display device of the same example embodiment.

FIG. 27 is a flowchart showing the flow of processing performed by a detection unit of the same example embodiment.

FIG. 28 is a flowchart showing the flow of processing performed by a control unit of the same example embodiment.

FIG. 29 is a diagram showing the configuration of a case where a color display is performed using the technique described in Patent Document 1.

FIG. 30 is a diagram showing the voltage waveform when a monochrome display is performed in the configuration of FIG. 29.

FIG. 31A is a diagram showing the illumination state and voltage waveform when a color display is performed in the configuration of FIG. 29.

FIG. 31B is a diagram showing the illumination state and voltage waveform when a color display is performed in the configuration of FIG. 29.

### EXAMPLE EMBODIMENT

### First Example Embodiment

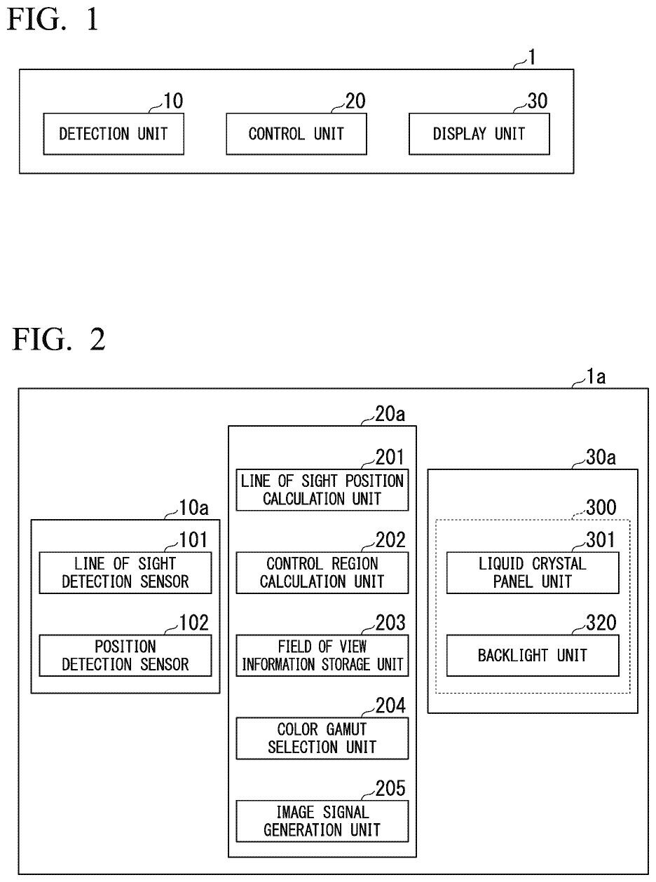

FIG. 1 is a block diagram showing a configuration of a display device 1 according to a first example embodiment. The display device 1 includes a detection unit 10, a control unit 20, and a display unit 30. The detection unit 10 detects a line of sight and position of a viewer viewing the display unit 30. The control unit 20 selects, based on information about the position of the viewer detected by the detection unit 10, a color gamut according to the position of a display region of the display unit 30, and displays an image in the selected color gamut on the display unit 30.

### Second Example Embodiment

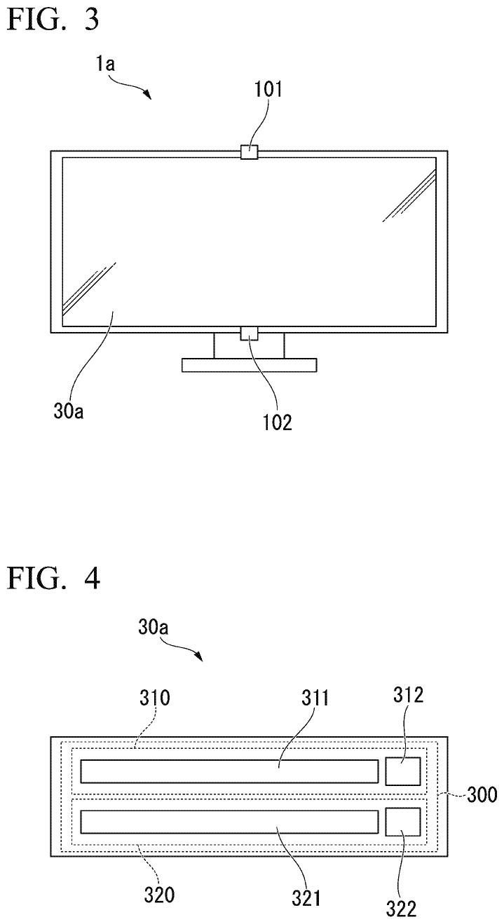

FIG. 2 is a block diagram showing an internal configuration of a display device 1a according to a second example embodiment. FIG. 3 is a diagram showing an outer appearance of the display device 1a. The display device 1a includes a detection unit 10a, a control unit 20a, and a display unit 30a. The detection unit 10a includes a line of sight detection sensor 101 and a position detection sensor 102.

The line of sight detection sensor 101 detects the line of sight of a viewer viewing an image displayed on a display panel 300 by the display unit 30a of the display device 1a, and outputs information indicating the direction of the detected line of sight as line of sight information.

The position detection sensor 102 is, for example, a human sensor including therein an internal infrared light or laser that detects the position of a viewer, and outputs position information indicating the position of the detected viewer. Here, the position information indicating the position of the viewer is, for example, information indicating the distance from the position detection sensor 102 to the viewer, and the direction in which the viewer is present. If the direction in which the viewer is present is known, such as when the display device 1a is the display of a personal computer, and the viewer is sitting in a position in front of the position detection sensor 102, it is possible to measure only the distance to the viewer, and to use information about the measured distance as the position information. For example, as shown in FIG. 3, the line of sight detection sensor 101 and the position detection sensor 102 are installed at predetermined positions in a bezel provided around the display unit 30a.

The control unit 20a includes a line of sight position calculation unit 201, a control region calculation unit 202, a field of view information storage unit 203, a color gamut selection unit 204, and an image signal generation unit 205. The line of sight position calculation unit 201 calculates, based on the position of the viewer detected by the position detection sensor 102 and the line of sight information about the viewer detected by the line of sight detection sensor 101, the position at which the line of sight of the viewer intersects the surface of the display panel 300 of the display unit 30a (hereunder, referred to as the line of sight position). The field of view information storage unit 203 stores in advance field of view information, which indicates a field of view angle measured in advance for each viewer.

The control region calculation unit 202 is a functional unit calculating the regions in which a color gamut is to be selected, and calculates a viewing region, which is the region of the display panel 300 the viewer is viewing, based on the line of sight position calculated by the line of sight position calculation unit 201, the position information detected by the position detection sensor 102, and the field of view information indicating the field of view angle of the viewer stored in advance by the field of view information storage unit 203.

The color gamut selection unit 204 selects, based on the viewing region calculated by the control region calculation unit 202, a color gamut according to the position of the display region of the display panel 300. The image signal generation unit 205 generates an image signal according to the color gamut selected by the color gamut selection unit 204, and outputs the generated image signal to the display unit 30a.

The display unit 30a includes a display panel 300 that serves as a display region in which an image is displayed based on an image signal, and the display panel 300 includes a liquid crystal panel unit 310 and a backlight unit 320.

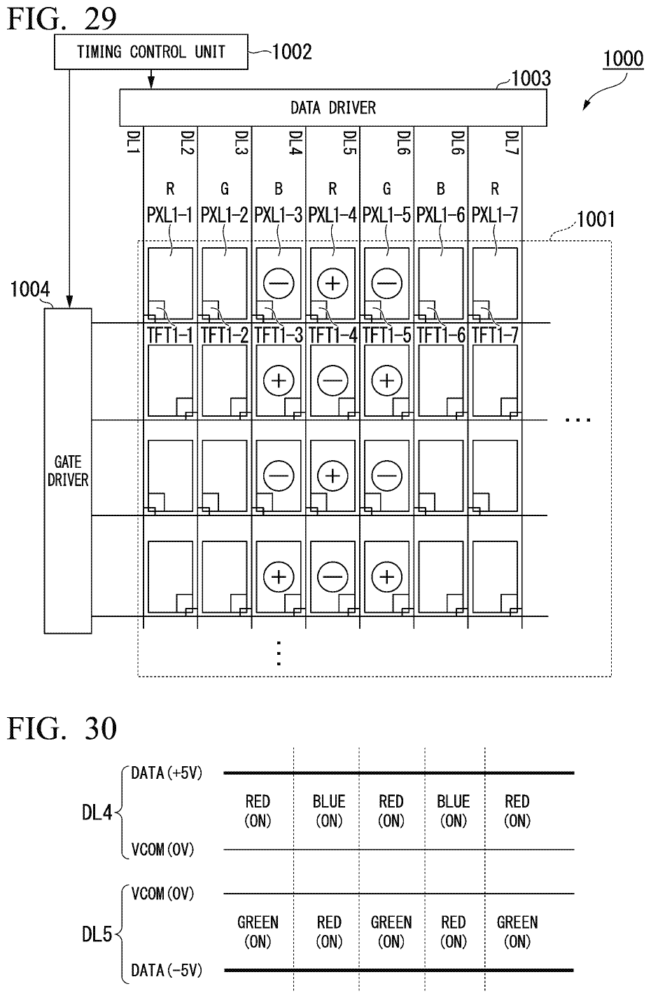

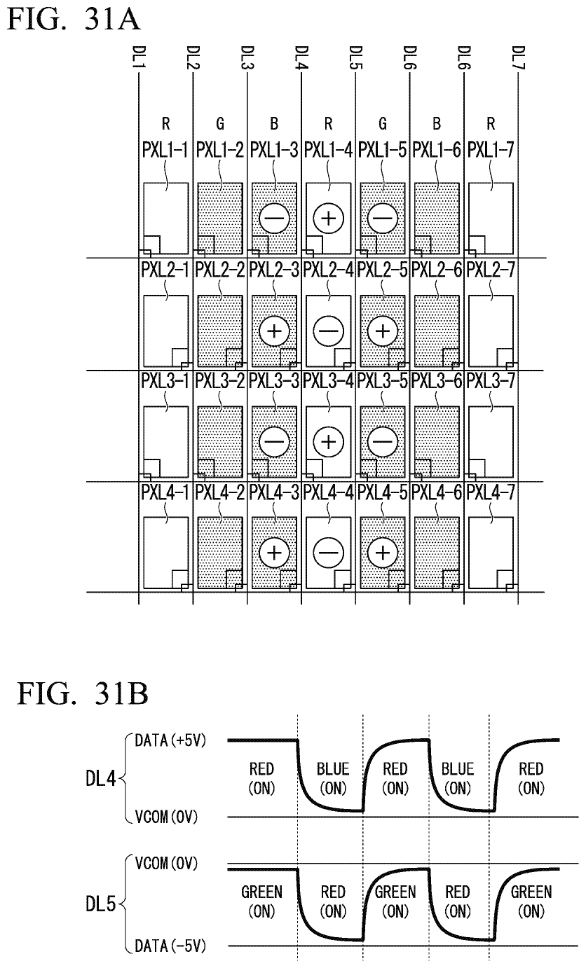

As shown in FIG. 4, the liquid crystal panel unit 310 includes a liquid crystal panel 311 and a liquid crystal panel control unit 312. For example, the liquid crystal display panel 1001 shown in FIG. 29 or the like is applied as the liquid crystal panel 311. For example, the liquid crystal panel control unit 312 is a functional unit including, as shown in FIG. 29, a timing control unit 1002, a data driver 1003, and a gate driver 1004, and generates a drive control signal based on an image signal and drives the liquid crystal panel 311 using the generated drive control signal.

The backlight unit 320 includes a light source 321 and a backlight control unit 322. The light source 321 is, for example, an LED (Light Emitting Diode), and the backlight control unit 322 causes the light source 321 to emit light with a predetermined brightness.

In the display device 1a, the brightness and spectrum characteristics of the backlight emitted by the backlight unit 320 are constant, and, the amount of light output as an image is adjusted by a dimming control for each of the three subpixels R, G, and B that form a single pixel of the liquid crystal panel 311. In other words, in the display device 1a, the color gamut is determined by the amount of light passing through the color filter of each color, that is to say, the ratio between the amount of light of each color. Therefore, the image signal generation unit 205 generates, according to the color gamut selected by the color gamut selection unit 204, an image signal that performs dimming control of each subpixel. Then, the display unit 30a displays the image using the image signal generated by the image signal generation unit 205, which results in the image being displayed in a color gamut according to the position of the display region of the display panel 300.

### (Processing by Display Device of Second Example Embodiment)

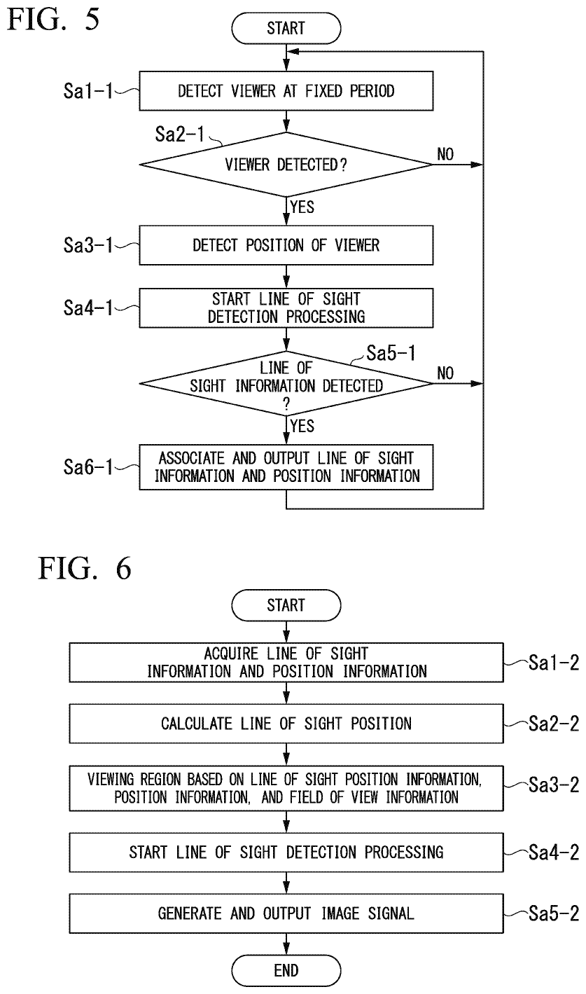

Next, the flow of the processing performed by the display device 1a will be described with reference to FIG. 5 to FIG. 8. FIG. 5 is a flowchart showing the flow of processing performed by the detection unit 10a. In the detection unit 10a, the position detection sensor 102 is, for example, a human sensor as mentioned above and detects the presence of a nearby person at a predetermined fixed period (step Sa1-1). The position detection sensor 102 determines whether or not a person has been detected (step Sa2-1).

If the position detection sensor 102 determines that a person has been detected (step Sa2-1, Yes), it determines that the person is a viewer 400, and detects the position of the viewer 400 (step Sa3-1). For example, the position detection sensor 102 detects the position of the detected viewer 400, or more specifically, the distance and direction to the position of the eyes of the viewer 400 by means of an internally provided infrared light or laser, and outputs the position information of the viewer 400, which includes the detected distance and direction, to the line of sight detection sensor 101. On the other hand, if the position detection sensor 102 determines that a person has not been detected (step Sa2-1, No), it repeats the processing of step Sa1-1.

When the line of sight detection sensor 101 receives the position information output by the position detection sensor 102, it starts to perform line of sight detection processing with respect to the viewer 400 (step Sa4-1). For example, the line of sight detection sensor 101 includes a camera therein, and captures an image that records the shape of the eyes of the viewer 400, which includes the inner corners of the eyes, and the movement of the irises of the eyeballs of the viewer 400. The line of sight detection sensor 101 detects the positions of the inner corners of the eyes and the position of the irises of the viewer 400 from the captured image. The line of sight detection sensor 101 detects the line of sight of the viewer 400 based on the positional relationship between reference points and moving points, taking the detected positions of the inner corners of the eyes as the reference points, and the irises as the moving points. The line of sight detection sensor 101 detects the line of sight information indicating the line of sight of the viewer 400, for example, as a solid angle indicating the direction of the line of sight of the viewer 400 with reference to the installation position of the line of sight detection sensor 101, and uses the detected solid angle indicating the direction of the line of sight of the viewer 400 as the line of sight information.

The line of sight detection sensor 101 determines whether or not line of sight information has been detected as a result of the line of sight detection processing (step Sa5-1). If the line of sight detection sensor 101 determines that line of sight information has not been detected (step Sa5-1, No), it returns the processing to step Sa1-1.

On the other hand, if the line of sight detection sensor 101 detects that line of sight information has been detected (step Sa5-1, Yes), it associates the line of sight information with the position information detected by the position detection sensor 102, outputs them to the control unit 20a, and returns the processing to step Sa1-1.

FIG. 6 is a flowchart showing the flow of processing performed by the control unit 20a. The line of sight position calculation unit 201 of the control unit 20a acquires the line of sight information and position information output by the line of sight detection sensor 101 of the detection unit 10a (step Sa1-2).

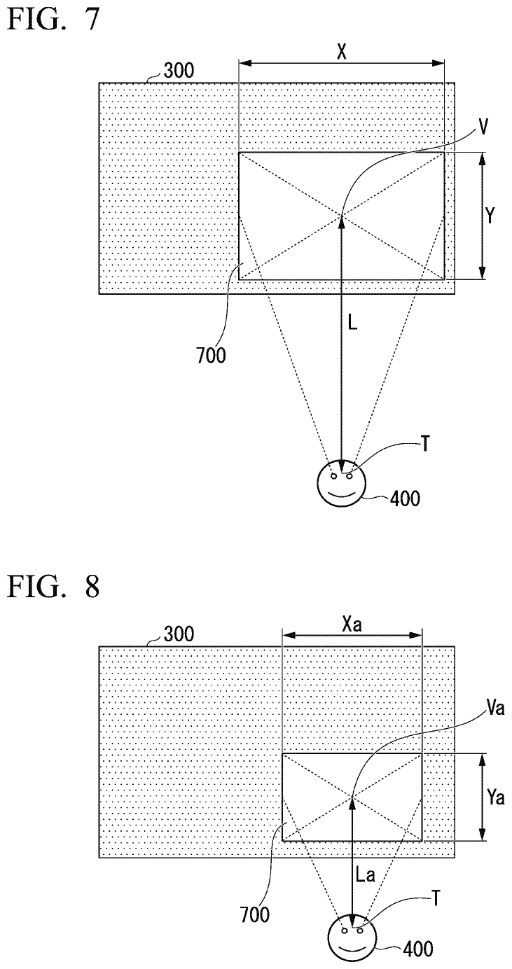

For example, as shown in FIG. 7, the line of sight position calculation unit 201 calculates, based on the acquired line of sight information and position information, the coordinate values of a line of sight position V on the surface of the display panel 300, which is the position at which the line of sight of the viewer 400 intersects the surface of the display panel 300 (step Sa2-2). The line of sight position calculation unit 201 outputs the coordinate values of the calculated line of sight position V and the position information of the viewer 400 to the control region calculation unit 202.

The control region calculation unit 202 calculates, based on the line of sight position V calculated by the line of sight position calculation unit 201, and the position information detected by the position detection sensor 102 indicating the position of the viewer 400, the distance L shown in FIG. 7, which is the distance between the line of sight position V and position T of the eyes of the viewer 400.

The control region calculation unit 202 reads the field of view information corresponding to the viewer 400 from the field of view information storage unit 203. The control region calculation unit 202 assumes that the region viewed by the viewer 400 is a rectangular shape centered at the line of sight position V and having a vertical-horizontal ratio determined according to the field of view angle of the viewer 400, and calculates, based on the viewing angle indicated by the field of view information that has been read, the distance L, and the line of sight position V, the rectangular region shown in FIG. 7 as a viewing region 700 having a vertical length Y, and a horizontal length X (step Sa3-2). Specifically, the control region calculation unit 202 calculates the coordinate values of the four vertexes of the viewing region 700 on the surface of the display panel 300.

As shown in FIG. 8, because it is assumed that the region viewed by the viewer 400 is a rectangular shape centered at the line of sight position V and having a vertical-horizontal length ratio determined according to the field of view angle of the viewer 400, the area of the viewing region 700 becomes smaller as the distance between the display panel 300 and position T of the eyes of the viewer 400 becomes shorter (La<L). Since the vertical-horizontal length ratio centered at the line of sight position Va is constant, the ratio between the lengths Xa and Ya shown in FIG. 8 is the same as the ratio between the lengths X and Y in FIG. 7.

The color gamut selection unit 204 selects a wider color gamut for the viewing region 700 calculated by the control region calculation unit 202 than for the region of the display panel 300 other than the viewing region 700, such as an sRGB 100% color gamut. Furthermore, the color gamut selection unit 204 selects a narrower color gamut for the region of the display panel 300 other than the viewing region 700 than the color gamut selected for the viewing region 700, such as an sRGB 50% or sRGB 30% color gamut which has a smaller color gamut coverage than an sRGB 100%, a grayscale color gamut, or a monochrome color gamut (step Sa4-2).

The image signal generation unit 205 acquires information provided from the outside about the image to be displayed on the display panel 300 of the display unit 30a, and generates an image signal based on the acquired information about the image and information about the color gamut selected by the color gamut selection unit 204. The image signal generation unit 205 outputs the generated image signal to the display unit 30a (step Sa5-2).

The display unit 30a acquires the image signal output by the image signal generation unit 205, and by displaying the image on the display panel 300 based on the acquired image signal, displays the image such that the viewing region 700 displays the wide color gamut image selected by the color gamut selection unit 204, and the region other than the viewing region 700 displays the narrow color gamut image selected by the color gamut selection unit 204.

In the configuration of the second example embodiment described above, the detection unit 10a detects the line of sight of the viewer 400 viewing the display unit 30a, and the position of the viewer 400. The control unit 20a calculates the viewing region 700 of the viewer 400 in the display unit 30a based on information about the line of sight and position of the viewer 400 detected by the detection unit 10, selects a wider color gamut for the calculated viewing region 700 than the color gamut of the display region of the display unit 30a other than the viewing region 700, and displays the image in the selected color gamut on the display unit 30a. As a result, the viewing region 700 viewed by the viewer 400 is capable of displaying the image with a wider color gamut so as to avoid a loss of visibility to the viewer and the display region other than the viewing region 700 can be displayed with a narrow color gamut having a low power consumption. Therefore, it is possible to display the image in an appropriate color gamut in the region being gazed at, and in the region other than that region, according to the viewing state of the viewer 400. Consequently, the power consumption can be reduced.

The display device 1a of the second example embodiment described above has been described assuming that there is a single viewer 400; however, a configuration which is capable of detecting the viewing region 700 for each of a plurality of viewers 400 may be used. If a display device 1a having such a configuration is applied to a public display which is viewed by a plurality of viewers 400, it is possible to perform an averaged display processing in which the wide color gamut region and the narrow color gamut region are mixed. Therefore, it is possible to reduce the deterioration in brightness caused by displaying over long periods, and the reliability can be improved. For example, in digital signage monitors, the power consumption and decrease in reliability due to displaying over long periods are problems when information is applied in a state where a viewer 400 is not present. Such problems can be solved by using a display device 1a which is capable of detecting the viewing region 700 of a plurality of viewers 400.

### First Additional Configuration Example 1 of Display Device of Second Example Embodiment

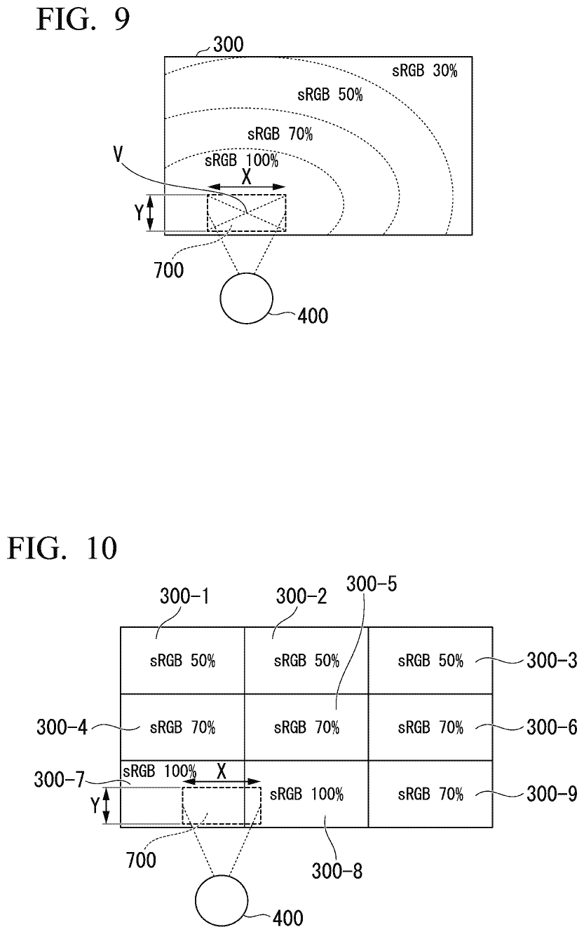

In the display device 1a of the second example embodiment described above, the color gamut selection unit 204 selects a wide color gamut for the viewing region 700, and selects a narrow color gamut for the region of the display panel 300 other than the viewing region 700. However, the configuration of the present invention is not limited to the present example embodiment. For example, as shown in FIG. 9, the color gamut selection unit 204 selects the sRGB 100%, which is a wide color gamut, for a fixed area centered at the line of sight position V of the viewing region 700, and which includes the viewing region 700. In contrast, the color gamut selection unit 204 may select, with respect to the region other than the viewing region 700, a color gamut for each region of a concentric oval shape including the viewing region 700 at the center, such that the color gamut becomes narrower in a stepwise fashion as the distance from the viewing region 700 increases. The region in which the color gamut is selected is not limited to a concentric oval shape, and may be a concentric circular shape having the center of the viewing region 700 as a reference.

Furthermore, the display device 1a of the second example embodiment described above has a configuration in which the display unit 30a includes a single display panel 300. However, for example, as shown in FIG. 10, the display unit 30 may have a configuration of a multi-tiling display including a plurality of display panels 300-1 to 300-9 arranged in close proximity in a matrix.

Suppose that, when the display device 1a has the configuration of the multi-tiling display shown in FIG. 10, a portion of the viewing region 700 of the viewer 400 overlaps with both the display panel 300-7 and the display panel 300-8. At this time, the color gamut selection unit 204 selects the sRGB 100%, which is a wide color gamut, with respect to the display panels 300-7 and 300-8, which overlap with the viewing region 700. In contrast, the color gamut selection unit 204 may select the color gamut of the display panels 300-1 to 300-6 and the display panel 300-9, which do not overlap with the viewing region 700, such that the color gamut becomes narrower in a stepwise fashion as the distance from the viewing region 700 increases. For example, the color gamut selection unit 204 selects an sRGB 70% color gamut for the display panels 300-4 to 300-6 and the display panel 300-9, which are adjacent to the display panels 300-7 and 300-8, and selects an sRGB 50% color gamut for the display panels 300-1 to 300-4.

As shown in FIG. 9 and FIG. 10, by selecting the color gamut so that the color gamut becomes narrower in a stepwise fashion as the distance from the viewing region 700 increases, it is possible to reduce the discomfort caused by the change in color gamut. On the other hand, because the image is displayed in a wide color gamut in the viewing region 700, the viewer 400 is capable of accurately acquiring a large amount of information from the image as is conventionally possible.

Furthermore, as a result of the color gamut becoming narrower in a stepwise fashion, it is possible to significantly reduce the power consumption, particularly in large displays and the like in which the display region is considerably larger than the viewing region 700 of the viewer 400. Moreover, as a result of the color gamut becoming narrower in a stepwise fashion, it is possible to obtain a larger power saving effect for images of simple patterns containing many primary colors. This is particularly effective for wide color gamut content such as signage, advertisements, and guidance displays. In addition, when, instead of the color gamut becoming narrower in a stepwise fashion as in FIG. 9 and FIG. 10, the step of the color gamut change is decreased so that the color gamut becomes narrower in a continuous fashion, the discomfort caused by the change in color gamut can be reduced even further.

In the configuration of the multi-tiling display shown in FIG. 10, the display unit 30a of the display device 1a has a configuration which includes a plurality of display panels 300-1 to 300-9. However, display panels that include a plurality of display devices that each include a single display panel, and the display device 1a of the second example embodiment, may be arranged in a matrix to form a multi-tiling display. In this case, the display device 1a of the second example embodiment communicates with the other display devices, and the control unit 20a selects the color gamut and displays the image on the display panel 300 of its own device and also selects the color gamut and displays the image on the display panels of the other display devices.

### Second Additional Configuration Example of Display Device of Second Example Embodiment

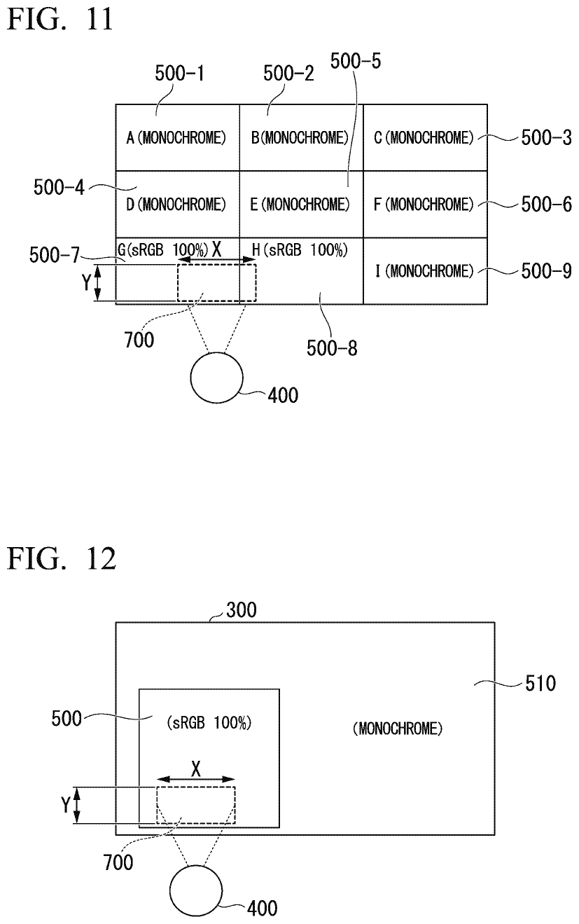

The display device 1a of the second example embodiment described above is configured to display a single image on the entire surface of the display panel 300. However, the configuration of the present invention is not limited to the present example embodiment. For example, as shown in FIG. 11, a configuration may be used in which a plurality of specific display regions 500-1 to 500-9 each capable of displaying the same or different images are determined in advance in the display region of the display panel 300. As an example, FIG. 11 shows a configuration example of a surveillance display, in which the specific display regions 500-1 to 500-9 respectively display surveillance images A to I.

Suppose that, as shown in FIG. 11, a portion of the viewing region 700 of the viewer 400 overlaps with both the specific display region 500-7 and the specific display region 500-8. At this time, the color gamut selection unit 204 selects the sRGB 100%, which is a wide color gamut, with respect to the specific display regions 500-7 and 500-8, which overlap with the viewing region 700. In contrast, the color gamut selection unit 204 may select a narrower color gamut for the specific display regions 500-1 to 500-6 and the specific display region 500-9, which do not overlap with the viewing region 700, than for the specific display regions 500-7 and 500-8, such as a monochrome color gamut.

Furthermore, as shown in FIG. 12, a specific display region 500 having an arbitrary position and arbitrary size may be selectable on the display panel 300, such as an operation display region by a PinP (Picture in Picture) or an OSD (On Screen Display). The number of specific display regions 500 is not limited to one, and a plurality may be selectable.

Suppose that, as shown in FIG. 12, all or part of the viewing region 700 of the viewer 400 overlaps with the specific display region 500. At this time, the color gamut selection unit 204 selects the sRGB 100%, which is a wide color gamut, for the specific display region 500, which overlaps with the viewing region 700. On the other hand, the color gamut selection unit 204 may select a narrower color gamut for the region 510 other than the specific display region 500 than for the specific display regions 500-7 and 500-8, such as a monochrome color gamut. The configuration of the first configuration example shown in FIG. 9 and FIG. 10 may be applied to the second configuration example shown in FIG. 11 and FIG. 12, such that the color gamut is selected to become a narrower color gamut as the distance from the viewing region 700 increases.

### Third Example Embodiment

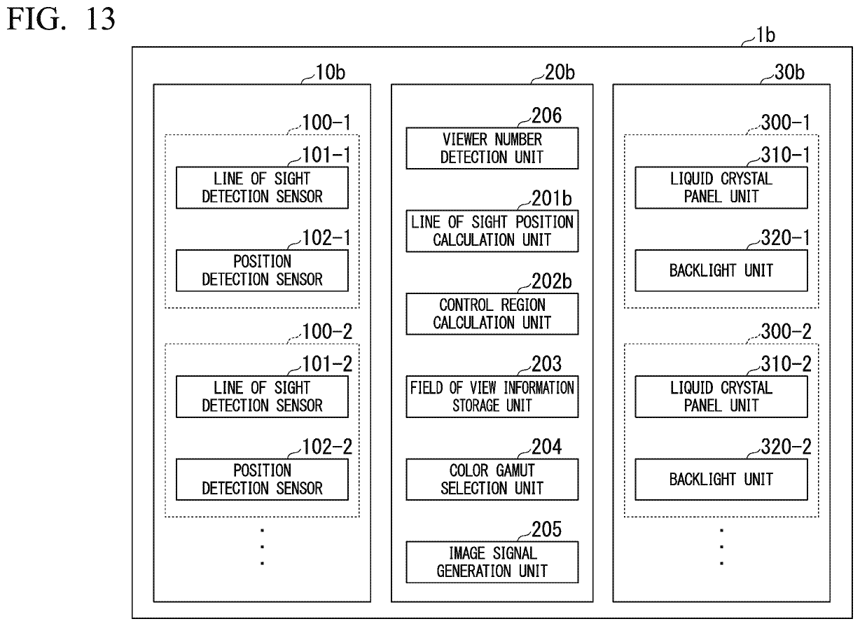

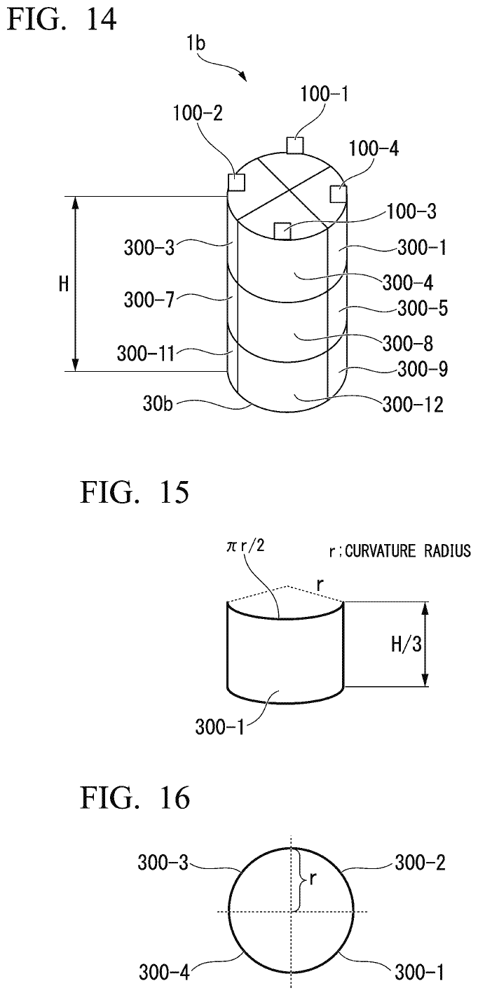

FIG. 13 is a block diagram showing an internal configuration of a display device 1b according to a third example embodiment. FIG. 14 is a diagram showing an outer appearance of the display device 1b. In the display device 1b of the third example embodiment, the same components as those of the display device 1a of the second example embodiment are assigned the same reference symbols, and the components that are different will be described below.

The display device 1b includes a detection unit 10b, a control unit 20b, and a display unit 30b. As shown in FIG. 14, the detection unit 10b includes a plurality of sensor units 100-1 and 100-4 installed near the edge of a base surface at the top of the cylindrical display unit 30b. The sensor units 100-1 to 100-4 respectively include line of sight detection sensors 101-1 to 101-4 and position detection sensors 102-1 to 102-4. The line of sight detection sensors 101-1 to 101-4 each have the same configuration as the line of sight detection sensor 101 of the second example embodiment. The position detection sensors 102-1 to 102-4 each have the same configuration as the position detection sensor 102 of the second example embodiment. Further, when information is output to the control unit 20b, unit position information indicating the positions of each of the sensor units 100-1 to 100-4 on the display unit 30b is added and then output.

The control unit 20b includes a viewer number detection unit 206, a line of sight position calculation unit 201b, a control region calculation unit 202b, a field of view information storage unit 203, a color gamut selection unit 204, and an image signal generation unit 205.

In the control unit 20b, the viewer number detection unit 206 counts the number of pieces of information being a combination of the unit position information, being the output information which is output by each of the sensor units 100-1 to 100-4, and the line of sight information and position information of the viewer 400, and uses the counted number as the number of viewers 400. Furthermore, the viewer number detection unit 206 outputs the acquired output information to the control region calculation unit 202b.

The control region calculation unit 202b calculates, based on information about the shape of the display region of the display unit 30b provided in advance, the unit position information, and the position information of the viewer 400, a blind spot region of the display region of the display unit 30b that cannot be viewed even when the line of sight is moved from the position of the viewer 400 since the display unit 30b is curved. Furthermore, the control region calculation unit 202b calculates, based on the calculated blind spot region, the visible region of the display region other than the blind spot region. Moreover, the control region calculation unit 202b calculates, based on information about the line of sight position of the viewer 400 calculated by the line of sight position calculation unit 201b and the field of view information of the viewer 400, the viewing region and visible region included in the calculated visible region.

The line of sight position calculation unit 201b calculates, based on information about the shape of the display region of the display unit 30b provided in advance, the unit position information, and the line of sight information and position information of the viewer 400, coordinate values of the line of sight position on the display region, which is the point of intersection between the line of sight and the display region.

As shown in FIG. 14, the display unit 30b includes a plurality of display panels 300-1 to 300-12. The display panels 300-1 to 300-12 respectively include liquid crystal panel units 310-1 to 310-12 and backlight units 320-1 to 320-12. Each of the liquid crystal panel units 310-1 to 310-12, except for having a different shape, have the same configuration as the liquid crystal panel unit 310 of the second example embodiment. Also, each of the backlight units 320-1 to 320-12, except for having a different shape, have the same configuration as the backlight unit 320 of the second example embodiment.

Each of the display panels 300-1 to 300-12 have the same shape. For example, as shown in FIG. 15, the display panel 300-1 has a shape having a radius of curvature “r”, an arc length of “πr/2”, which is one quarter of the circumference, and a height of “H/3”. A cylinder having a height of “H/3” is formed as a result of arranging and combining the four display panels 300-1 to 300-4 as shown in FIG. 16. As a result of stacking three such layers, as shown in FIG. 14, the display unit 30b becomes a cylindrical display having a height “H”, a circumference “2πr”, and a cylindrically shaped display region having an area of “2πrH”. Information indicating the height “H” and the radius of curvature “r” of the cylindrical shape serves as the above-mentioned preliminary provided information about the shape of the display region of the display unit 30b.

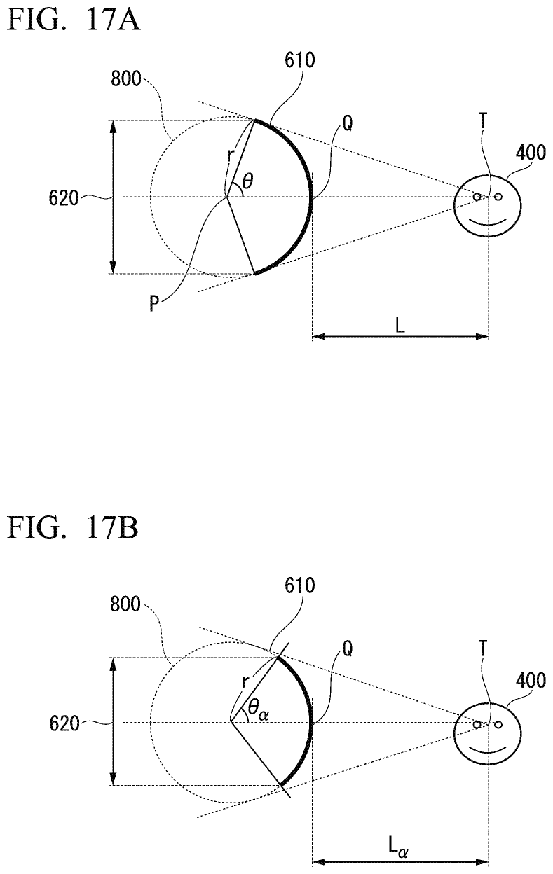

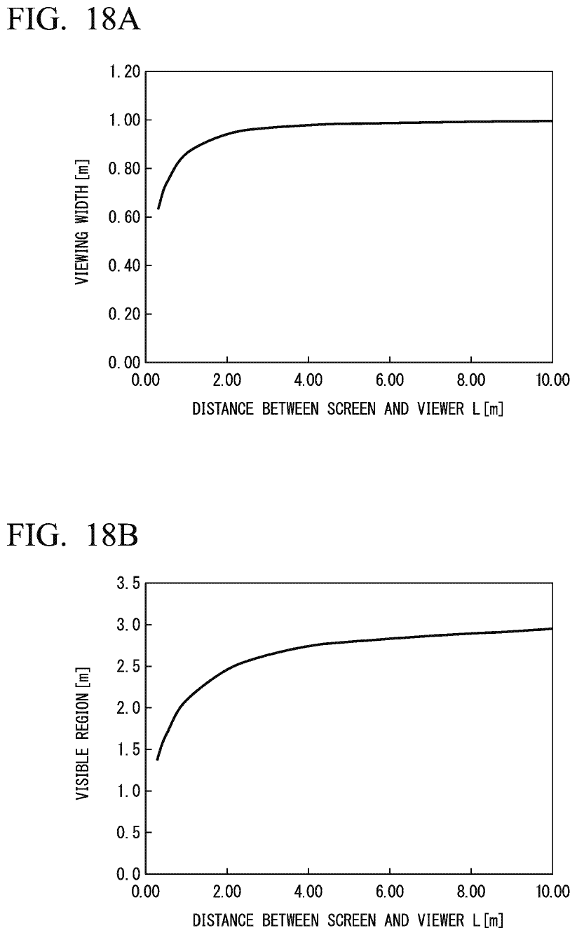

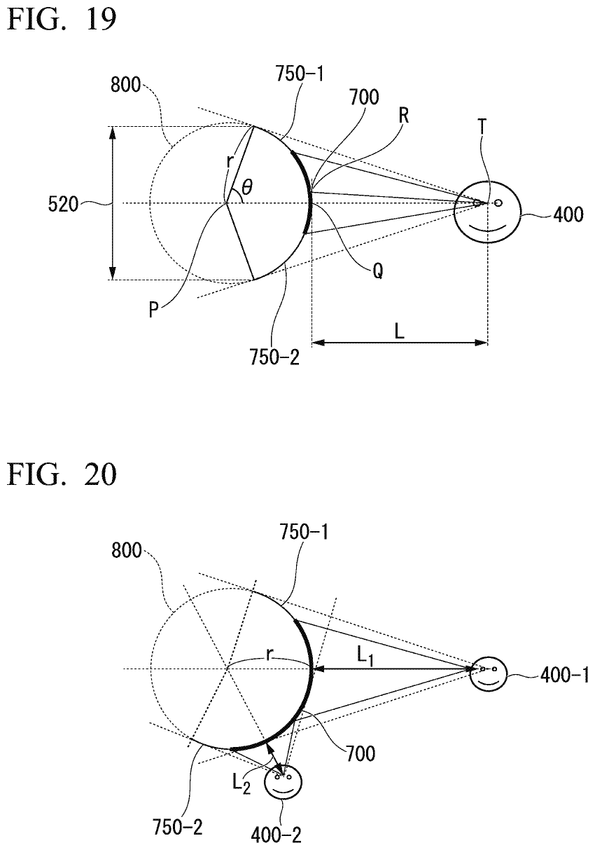

Next, the five types of regions of the display unit 30b according to the third example embodiment, namely a display region, a visible region, a viewing region, a difficult viewing region, and a blind spot region will be described with reference to FIG. 17A, FIG. 17B, FIG. 18A, FIG. 18B, and FIG. 19. First, the display region is the entire region in which an image can be displayed on the cylindrical display formed by the display panels 300-1 to 300-12.

FIG. 17A is a diagram showing the positional relationship between a cross-sectional view of the display unit 30b and the viewer 400 at the height of the eye position of the viewer 400. In FIG. 17A, the position of the central axis of the cylindrical display region is denoted by P, and the point of intersection between the straight line connecting position T and position P and the display area is denoted by Q. The length from position Q to position T is the shortest distance between the display region and the eye position T of the viewer 400, and this length is denoted by L.

In FIG. 17A, the visible region 610 is, as indicated by the thick line, the entire region of the display region that the viewer 400 is capable of viewing from position T by moving the line of sight. In contrast, the blind spot region 800 is the region that the viewer 400 is unable to view even by moving the line of sight, and is the remaining region after subtracting the visible region 610 from the display region.

In other words, of the two regions divided by the two tangent points at which the tangent lines that pass through position T contact with the circle, one region on the viewer 400 side is the visible region 610, and the other region is the blind spot region 800. Of the length of the circumference “27πr” of the display unit 30b, the length occupied by the visible region 610 is “2r×a cos(r/(r+L))”. Therefore, as shown in FIG. 17B, when the length between position T and position Q becomes shorter (L_{α}<L), the length of the circumference occupied by the visible region 610 also becomes shorter.

For example, the relationship between the distance L and the viewing width 620, which is the straight line distance between the two tangent points, has the relationship depicted in the graph in FIG. 18A when the radius of curvature “r=1 m”. Furthermore, the relationship between the length L and the length of the circumference occupied by the visible region 610 has the relationship depicted in the graph in FIG. 18B.

FIG. 19 is a diagram showing the relationship between the visible region 610, the viewing region 700, and difficult viewing regions 750-1 and 750-2. It is assumed that the line of sight position calculated by the line of sight position calculation unit 201b based on the line of sight information and the position information of the viewer 400 is the line of sight position R, which is slightly offset from the position Q.

The viewing region 700 is a region that is indicated by a thick line in FIG. 19 and that is defined by the field of view angle of the viewer 400 centered at the line of sight position R. The difficult viewing regions 750-1 and 750-2 are the remaining regions after subtracting the viewing region 700 from the visible region 610.

Furthermore, as shown in FIG. 20, when a plurality of viewers 400-1 and 400-2 are present, the visible region 610 of each viewer 400-1 and 400-2 is merged and the blind spot region 800 is recalculated. Moreover, in the merged visible region 610, the visible region 700 of each viewer 400-1 and 400-2 is merged, and the difficult viewing regions 750-1 and 750-2 are recalculated. If viewers 400-1, 400-2, . . . , are present in all directions, the entire surface of the display region becomes the viewing region 700.

### (Processing by Display Device of Third Example Embodiment)

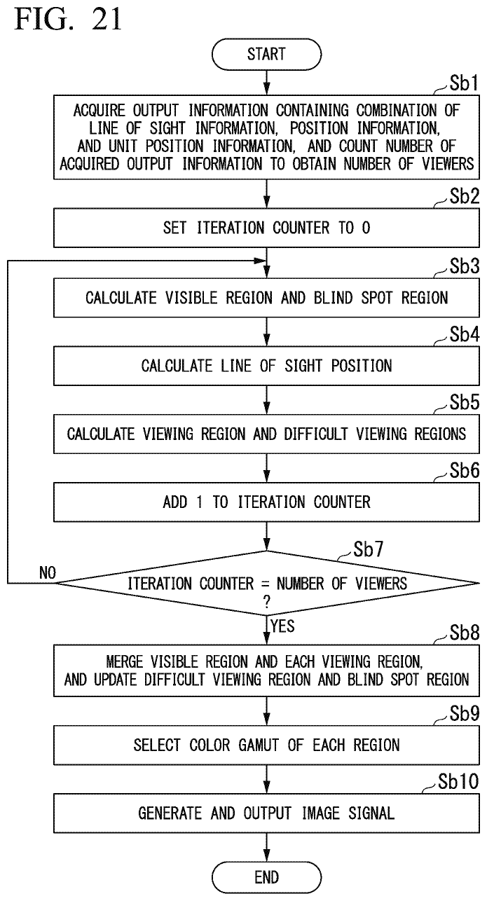

Next, the flow of the processing performed by the display device 1b will be described with reference to FIG. 21. Each of the sensor units 100-1 to 100-4 of the detection unit 10b perform processing according to the flowchart of FIG. 5, which shows the flow of the processing performed by the detection unit 10b of the second example embodiment. If line of sight information has been detected, in the processing of step Sa6-1, the line of sight detection sensors 101-1 to 101-4 each associate the position information detected by the corresponding position detection sensors 102-1 to 102-4 with the detected line of sight information, and output them to the control unit 20b after adding the corresponding unit position information.

FIG. 21 is a flowchart showing the flow of processing performed by the control unit 20b. The viewer number detection unit 206 of the control unit 20b acquires output information being a combination of the unit position information, which is output by the line of sight detection sensors 101-1 to 101-4 included in the sensor units 100-1 to 100-4 of the detection unit 10b, and the line of sight information and position information of the viewer 400, and counts the number of pieces of acquired output information. The viewer number detection unit 206 uses the number obtained from the count as the number of viewers, and writes and stores it in an internal storage area. The viewer number detection unit 206 outputs the acquired output information to the control region calculation unit 202b (step Sb1).

When the control region calculation unit 202b acquires the information output by the viewer number detection unit 206, it sets “0” to an internally provided repetition counter (step Sb2).

The control region calculation unit 202b selects, from among the information which combines the unit position information and the line of sight information and position information of the viewer 400, one piece of information for which a visible region 610 and a blind spot region 800 have not been calculated. The control region calculation unit 202b calculates, based on information about the shape of the display region of the display unit 30b provided in advance, the selected unit position information, and the position information of the viewer 400, the distance L shown in FIG. 17A, which is the distance between position Q and position T of the eyes of the viewer 400.

The control region calculation unit 202b calculates the visible region 610 based on the calculated distance L and the radius of curvature r of the display unit 30b determined in advance. Furthermore, the control region calculation unit 202b calculates as the blind spot region 800 the region obtained by subtracting the calculated visible region 610 from the display region of the display unit 30b (step Sb3).

The control region calculation unit 202b outputs the selected unit position information, and the line of sight information and position information of the viewer 400, to the line of sight position calculation unit 201b. The line of sight position calculation unit 201b calculates, based on information about the shape of the display region of the display unit 30b provided in advance, the unit position information, and the line of sight information and position information of the viewer 400, coordinate values of the line of sight position R of the display region shown in FIG. 19, at which the display region and the line of sight intersect. The line of sight position calculation unit 201b outputs the coordinate values of the calculated line of sight position R of the display region, to the control region calculation unit 202b (step Sb4).

The control region calculation unit 202b reads the field of view information corresponding to the viewer 400 stored by the field of view information storage unit 203. The control region calculation unit 202b calculates the viewing region 700 of the visible region 610 based on the coordinate values of the line of sight position R in the display region calculated by the line of sight position calculation unit 201b and the field of view information that has been read. The control region calculation unit 202b calculates the difficult viewing regions 750-1 and 750-2 by subtracting the calculated viewing region 700 from the visible region 610 (step Sb5).

The control region calculation unit 202b adds “1” to the repetition counter (step Sb6), and determines whether or not the value of the repetition counter is equal to the number of viewers stored by the storage area inside the viewer number detection unit 206 (step Sb7).

If the control region calculation unit 202b determines that the value of the repetition counter is not equal to the number of viewers stored by the storage area inside the viewer number detection unit 206 (step Sb7, No), it repeats the processing from step Sb3.

If the control region calculation unit 202b determines that the value of the repetition counter is equal to the number of viewers stored by the storage area inside the viewer number detection unit 206 (step Sb7, Yes), then, as shown in FIG. 20, when a plurality of calculated viewing regions 700 are present, it merges the plurality of calculated visible regions 610, and recalculates and updates the blind spot region 800. Furthermore, the control region calculation unit 202b merges the calculated plurality of viewing regions 700, and recalculates and updates the difficult viewing regions 750-1 and 750-2 (step Sb8). If a plurality of viewing regions 700 do not exist, the processing of step Sb8 is not performed.

The color gamut selection unit 204 selects a wider color gamut for the viewing region 700 calculated by the control region calculation unit 202b than for the region of the display region other than the viewing region 700, such as a sRGB 100% color gamut. Furthermore, the color gamut selection unit 204 selects a narrower color gamut for the difficult viewing regions 750-1 and 750-2 than the color gamut selected for the viewing region 700, such as a sRGB 50% or sRGB 30% color gamut, or a grayscale color gamut, which have a smaller color gamut coverage than an sRGB 100%. The color gamut selection unit 204 selects a narrower color gamut for the blind spot region 800 calculated by the control region calculation unit 202b than for the difficult viewing regions 750-1 and 750-2, such as a monochrome color gamut (step Sb9).

The image signal generation unit 205 acquires information provided from the outside about the image to be displayed on the display region of the display unit 30b, and generates an image signal based on the acquired information about the image and information about the color gamut selected by the color gamut selection unit 204. The image signal generation unit 205 outputs the generated image signal to the display unit 30b (step Sb10).

By acquiring the image signal output by the image signal generation unit 205 and by displaying the image in the display region based on the acquired image signal, the display unit 30b displays the image in a wide color gamut in the viewing region 700, displays the image in a narrower color gamut than the viewing region 700 in the difficult viewing regions 750-1 and 750-2, and displays the image in a narrower color gamut than the difficult viewing regions 750-1 and 750-2 in the blind spot region 800.

As a result of the configuration of the third example embodiment described above, the control unit 20b calculates the blind spot region 800 of the viewer 400 in the display unit 30b based on the position information of the viewer 400 detected by the detection unit 10a, selects a narrower color gamut for the calculated blind spot region 800 than the color gamut of the display region other than the blind spot region 800, and displays the image in the selected color gamut on the display unit 30b. As a result, the image can be displayed with a narrow color gamut having a low power consumption in the blind spot region 800, which cannot be viewed by the viewer 400.

Furthermore, the control unit 20b calculates the viewing region 700 included in the visible region 610, which is the display region other than the blind spot region 800, based on the line of sight information of the viewer 400 detected by the detection unit 10b, selects a wider color gamut for the calculated viewing region 700 than the color gamut of the display region other than the viewing region 700, and displays the image in the selected color gamut on the display unit 30b. As a result, the viewing region viewed by the viewer 400 is capable of displaying the image with a wider color gamut so as to avoid a loss of visibility to the viewer. Moreover, the difficult viewing regions 750-1 and 750-2 that are different from the viewing region 700 and the blind spot region 800 are capable of displaying the image in a color gamut between the color gamut of the viewing region 700 and the color gamut of the blind spot region 800. Therefore, the display device 1b is capable of displaying the image in an appropriate color gamut according to the viewing state of the viewer 400, and as a result, the power consumption can also be reduced.

In addition, the display device 1b of the third example embodiment is configured to be viewed by a plurality of viewers 400 at the same time, and is capable of performing an averaged display processing that displays an image in a display region by mixing images that have a color gamut corresponding to the viewing state of the viewers 400. Therefore, it is possible to reduce the deterioration in brightness caused by displaying over long periods, and the reliability can be improved. For example, in digital signage monitors, the power consumption and decrease in reliability due to displaying over long periods are problems when information is applied in a state where a viewer 400 is not present; however, such problems can be solved by using the display device 1b.

### First Additional Configuration Example of Display Device of Third Example Embodiment

As shown in FIG. 17A and FIG. 17B, in the display device 1b of the third example embodiment described above, the region of the visible region 610 changes according to the distance L between the viewer 400 and the display region. Therefore, as shown in FIG. 17A, when the distance L between the viewer 400 and the display region is long, the image signal generation unit 205 may generate an image signal that displays the image with an enlarged magnification according to the size of the visible region 610 or viewing region 700. That is to say, in the third example embodiment, the image is displayed on the display unit 30b with a magnification corresponding to the distance from the display region of the display unit 30b to the viewer 400. Consequently, as the image becomes more difficult to view when the distance L between the display region and the viewer 400 becomes long, by enlarging the image, though the information included in the image is reduced, the viewer 400 is able to view the image clearly and is able to obtain accurate information.

In contrast, as shown in FIG. 17B, when the distance L between the viewer 400 and the display region is short, the image signal generation unit 205 may generate an image signal that displays the image with a reduced magnification according to the size of the visible region 610 or viewing region 700. When the distance L between the display region and the viewer 400 becomes short, the image becomes easier to view. More information can be included in the image by reducing the image. As a result, the viewer 400 can obtain more information at once.

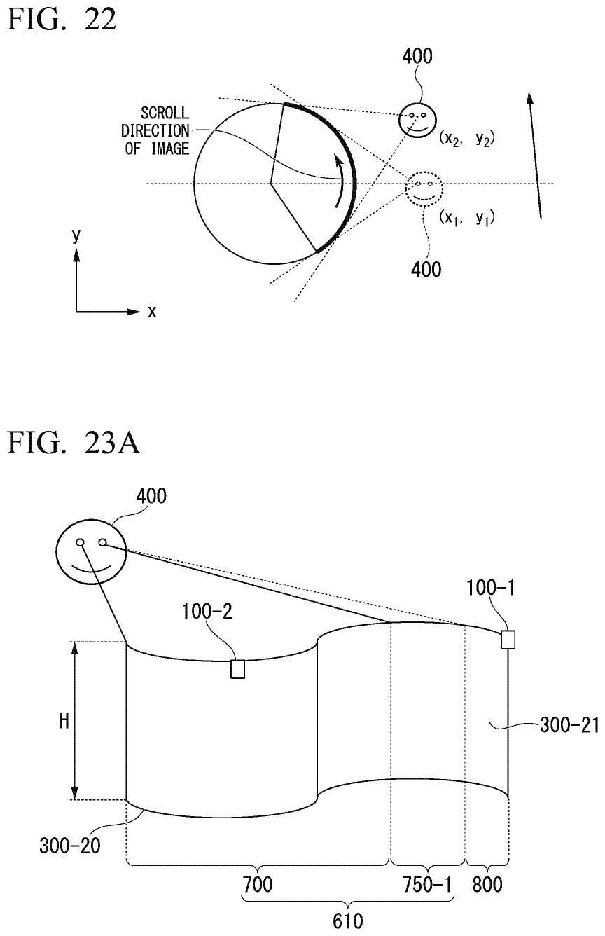

Furthermore, as shown in FIG. 22, if the position detection sensors 102-1, 102-2, . . . , detect that the viewer 400 has moved from position (x₁, y₁) to position (x₂, y₂), the image signal generation unit 205 may generate an image signal that displays the image in the display region so that it is scrolled according to the movement direction of the viewer 400. Consequently, the display unit 30b is capable of continuously displaying the information that is desired to be shown to the viewer 400 in the display region being viewed by the viewer 400.

### Second Additional Configuration Example of Display Device of Third Example Embodiment

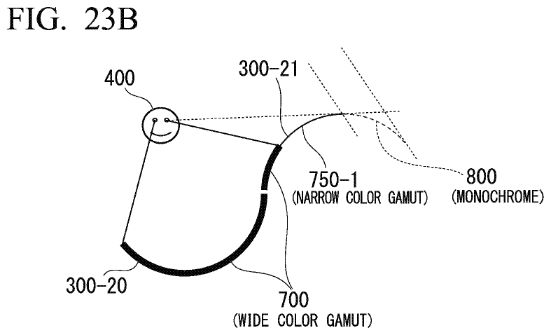

Moreover, as an additional configuration example of the third example embodiment described above, for example, as shown in FIG. 23A and FIG. 23B, the display unit 30b may be configured as a curtain-shaped display that combines two curved display panels 300-20 and 300-21 having a radius of curvature r and a height H. FIG. 23A is an external view and FIG. 23B is a cross-sectional view. Furthermore, except for the shape, the display panels 300-20 and 300-21 each have the same configuration as the display panels 300-1 to 300-12 of the third example embodiment.

In the case of the configuration shown in FIG. 23A and FIG. 23B, the display device 1b is capable of calculating a visible region 610 and a blind spot region 800 based on the shape of the display panels 300-20 and 300-21 and the line of sight information and position information of the viewer 400, and furthermore, it can calculate a viewing region 700 and a difficult viewing region 750-1 in the visible region 610.

### Fourth Example Embodiment

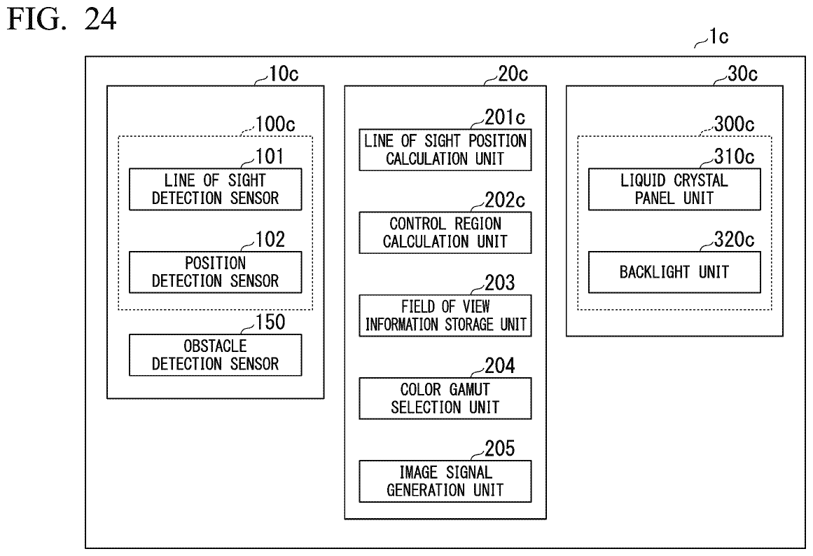

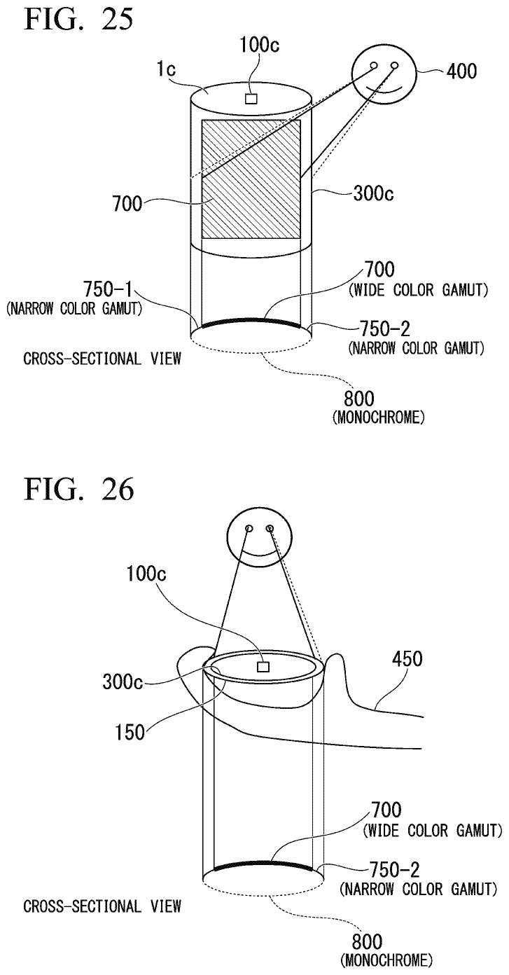

FIG. 24 is a block diagram showing an internal configuration of a display device 1c according to a fourth example embodiment. Furthermore, FIG. 25 and FIG. 26 are diagrams showing an outer appearance and a cross-section of the display device 1b. In the display device 1c of the fourth example embodiment, the same components as those of the display devices 1a and 1b of the second and third example embodiments are assigned the same reference symbols, and the components that are different will be described below.

The display device 1c includes a detection unit 10c, a control unit 20c, and a display unit 30c. The display device 1c is, for example, a small portable device having a curved display region capable of a side roll display and a double-sided display, and as shown in FIG. 26, it may be held by a holding means 450 such as one or both hands of the viewer 400, or a fixing jig or the like.

As shown in FIG. 25, the detection unit 10c includes a sensor unit 100c installed on one of the bottom surfaces of the display device 1c, which has an oval cylindrical shape, and an obstacle detection sensor 150 attached so as to cover the curved surface of the display device 1c. The sensor unit 100c includes a line of sight detection sensor 101 and a position detection sensor 102. The obstacle detection sensor 150 is, for example, a capacitance type sensor, and detects obstacle position information indicating the position of an obstacle making contact with the obstacle detection sensor 150.

The control unit 20c includes a line of sight position calculation unit 201c, a control region calculation unit 202c, a field of view information storage unit 203, a color gamut selection unit 204, and an image signal generation unit 205. In the control unit 20c, the line of sight position calculation unit 201c calculates, based on information about the shape of the display region of the display unit 30c provided in advance, and the line of sight information and position information of the viewer 400, a line of sight position which is the point of intersection between the display region and the line of sight.

For example, as shown in FIG. 25, like the control region calculation unit 202b of the third example embodiment, the control region calculation unit 202c calculates a blind spot region 800 of the display region, which is a region that cannot be viewed from the position of the viewer 400 even by moving the line of sight. Furthermore, if obstacle position information detected by the obstacle detection sensor 150 is present, the control region calculation unit 202c calculates the region of the display region that can no longer be viewed because of the obstacle based on the obstacle position information. Moreover, the control region calculation unit 202c adds the calculated region to the calculated blind spot region 800, and updates the blind spot region 800.

In addition, the control region calculation unit 202c calculates a region obtained by subtracting the blind spot region 800 from the display region, which corresponds to the visible region 610 of the third example embodiment. Also, the control region calculation unit 202c calculates the viewing region 700, and the difficult viewing regions 750-1 and 750-2, based on the calculated region corresponding to the visible region 610, information about the line of sight position of the viewer 400 calculated by the line of sight position calculation unit 201c, and the field of view information of the viewer 400.

The display unit 30c includes a display panel 300c. The display panel 300c includes a liquid crystal panel unit 310c and a backlight unit 320c. The liquid crystal panel unit 310c, except for having a different shape, has the same configuration as the liquid crystal panel unit 310 of the second example embodiment. Further, the backlight unit 320c, except for having a different shape, has the same configuration as the backlight unit 320 of the second example embodiment.

### Processing by Display Device of Fourth Example Embodiment

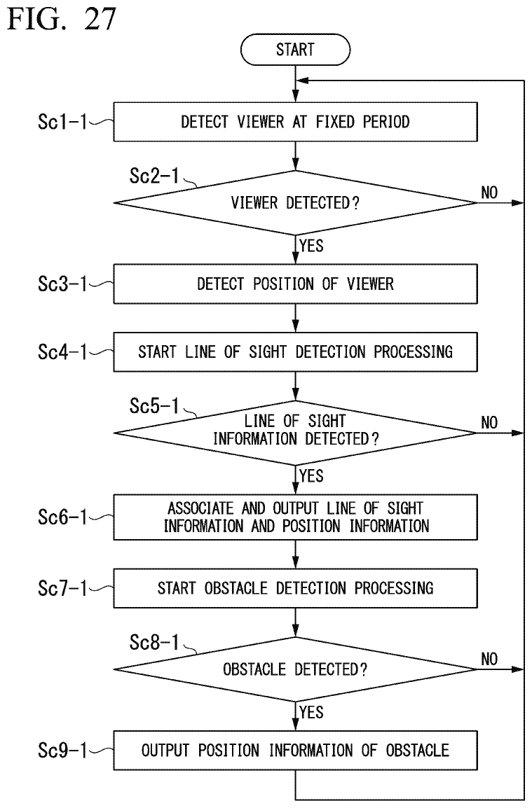

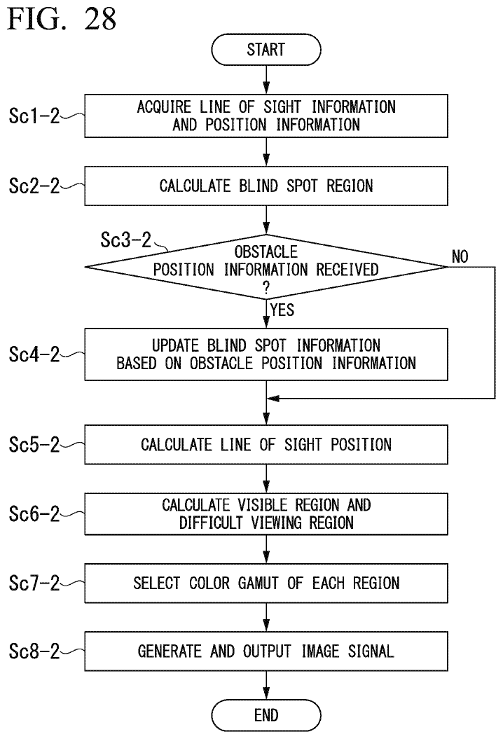

Next, the flow of the processing performed by the display device 1c will be described with reference to FIG. 27 and FIG. 28. FIG. 27 is a flowchart showing the flow of processing performed by the detection unit 10c. In the processing of steps Sc1-1 to Sc6-1 in FIG. 27, the line of sight detection sensor 101 and the position detection sensor 102 perform the same processing as the processing of steps Sa1-1 to Sa6-1 shown in FIG. 5. After step Sc6-1, the obstacle detection sensor 150 starts detection processing for an obstacle making contact with the obstacle detection sensor 150 (step Sc7-1).

The obstacle detection sensor 150 determines whether or not an obstacle has been detected (step Sc8-1). If the obstacle detection sensor 150 determines that an obstacle has not been detected (step Sc8-1, No), it returns the processing to step Sc1-1. On the other hand, if the obstacle detection sensor 150 detects that an obstacle has been detected (step Sc8-1, Yes), it detects obstacle position information indicating the position of the obstacle in the display region of the display unit 30c, outputs the detected obstacle position information to the control unit 20c (step Sc9-1), and returns the processing to step Sc1-1.

FIG. 28 is a flowchart showing the flow of processing performed by the control unit 20c. In the control unit 20c, the control region calculation unit 202c acquires the line of sight information and position information of the viewer 400 output by the line of sight detection sensor 101 of the detection unit 10c (step Sc1-2).

The control region calculation unit 202c calculates, based on information about the shape of the display region of the display unit 30c provided in advance, and the position information of the viewer 400, the blind spot region 800 shown in FIG. 25 (step Sc2-2). The control region calculation unit 202c determines whether or not obstacle position information has been received from the obstacle detection sensor 150 (step Sc3-2). If the control region calculation unit 202c determines that obstacle position information has not been received from the obstacle detection sensor 150 (step Sc3-2, No), it advances the processing to step Sc5-2.

On the other hand, if the control region calculation unit 202c determines that obstacle position information has been received from the obstacle detection sensor 150 (step Sc3-2, Yes), the control region calculation unit 202c detects the region of the display region that can no longer be viewed because of the obstacle, based on the obstacle position information detected by the obstacle detection sensor 150, and then adds the detected region to the blind spot region 800 and updates the blind spot region 800 (step Sc4-2).

The control region calculation unit 202c outputs the line of sight information and position information of the viewer 400 to the line of sight position calculation unit 201c. The line of sight position calculation unit 201c calculates, based on information about the shape of the display region of the display unit 30c provided in advance, and the line of sight information and position information of the viewer 400, coordinate values of the line of sight position on the display region, which is the point of intersection between the display region and the line of sight. The line of sight position calculation unit 201c outputs the calculated line of sight position information to the control region calculation unit 202c (step Sc5-2).

The control region calculation unit 202c calculates, in the remaining region after subtracting the blind spot region 800 from the display region, the viewing region 700 and the difficult viewing regions 750-1 and 750-2 based on the coordinate values of the viewing region in the display region calculated by the line of sight position calculation unit 201c and the position information of the viewer 400 (step Sc6-2).

As a result, for example, when it is not held by the hand of the viewer 400, the control region calculation unit 202c calculates, as shown in FIG. 25, the viewing region 700, the difficult viewing regions 750-1 and 750-2, and the blind spot region 800. In contrast, for example, when it is held by the hand of the viewer 400, because the difficult viewing region 750-1 in FIG. 25 is covered by an obstacle, the control region calculation unit 202c calculates, as shown in FIG. 26, the viewing region 700, the difficult viewing region 750-2, and the blind spot region 800.

In steps Sc7-2 and Sc8-2, the same processing as steps Sb9 and Sb10 of the third example embodiment is performed by the color gamut selection unit 204 and the image signal generation unit 205.

As a result, the display unit 30c acquires the image signal output by the image signal generation unit 205, and by displaying the image in the display region based on the acquired image signal, displays the image in a wide color gamut in the viewing region 700, displays the image in a narrower color gamut than the viewing region 700 in the difficult viewing regions 750-1 and 750-2, and displays the image in a narrower color gamut than the difficult viewing regions 750-1 and 750-2 in the blind spot region 800.

Consequently, as a result of it being held by a holding means 450, which is one or both hands of the viewer 400 or a fixing jig, the holding device 450 becomes an obstacle, and the display region that cannot be viewed by the viewer 400 can be made the blind spot region 800, and thereby, the power consumption can be further reduced.

In the configuration of the fourth example embodiment described above, the detection unit 10c detects the position of the obstacle obstructing the display of the display unit 30c. The control unit 20c calculates the blind spot region 800 of the viewer 400 based on the position of the viewer 400 detected by the detection unit 10c and the position of the obstacle, selects a narrower color gamut for the calculated blind spot region 800 than the color gamut of the display region other than the blind spot region 800, and displays the image in the selected color gamut on the display unit 30c. As a result, the display device 1c is capable of calculating the blind spot region 800 in consideration of the region that can no longer be viewed because of the obstacle, and, by displaying the image in a narrow color gamut having a low power consumption in the calculated blind spot region 800, the power consumption can be further reduced. Therefore, the display device 1c is capable of displaying the image in an appropriate color gamut according to the viewing state of the viewer 400, and as a result, the power consumption can be reduced.

In a conventional display device, the image is displayed with the same color gamut over the entire surface of the display; however, in the display devices 1a, 1b, and 1c of the second to fourth example embodiments, the image is displayed in a narrow color gamut in the region other than the viewing region 700, which is not being gazed at by the viewer 400. As described using Patent Document 1 as an example, even if the brightness value is the same between the color display and the grayscale display or monochrome display, the amount of power consumed is larger when generating the color display, which has a wide color gamut. Therefore, by using a wide color gamut in the viewing region 700 and a narrow color gamut outside the viewing region 700, it is possible to reduce the power consumption compared to a case where the entire display region is displayed in a wide color gamut. Even in this case, because the display devices 1a, 1b, and 1c display the image in a wide color gamut in the viewing region 700 being gazed at by the viewer 400, the viewer 400 is capable of accurately acquiring a large amount of information from the image as in the conventional case. In other words, the display devices 1a, 1b, and 1c enable the required information to be displayed in the viewing region 700 being gazed at by the viewer 400, and enable the power consumption to be reduced while displaying a minimal amount of information in the region other than the viewing region 700, which is not being gazed at by the viewer 400.

Furthermore, in the display devices 1a, 1b, and 1c of the second to fourth example embodiments described above, the viewing state of the viewer 400 can be periodically detected by the detection units 10a, 10b, and 10c. Therefore, because the wide color gamut viewing region 700 performs tracking based on the position and movement of the viewer 400, the power consumption can be reduced while enabling high quality display information to be provided to the viewer 400.

In the second to fourth example embodiments, the field of view information storage unit 203 stores field of view information indicating the field of view angle of each viewer 400 in advance. The reasons for using the field of view angle of each viewer 400 is as follows. For example, if the field of view angle is made a fixed angle, some viewer 400 may visually recognize a dark section in the viewing region 700. In contrast, if the field of view angle is fixed to a wide angle, the region of the viewing region 700 may become larger than necessary, and the power saving effect may be reduced. Consequently, as a result of the field of view information storage unit 203 storing in advance a field of view angle that differs depending on the viewer 400, as the field of view information for each viewer 400, it becomes possible to accurately specify a field of view range using the stored field of view information.

In the method of storing the field of view information in the field of view information storage unit 203, for example, the distance between the display units 30a, 30b, and 30c and the viewer 400 is set to a fixed length in advance. Then, the field of view angle is measured in advance based on a viewing state in which a predetermined image is displayed on the display units 30a, 30b, and 30c, and the line of sight of the viewer 400 is directed toward the center of the display units 30a, 30b, and 30c, and the measured field of view angle is written and stored to the field of view information storage unit 203 as field of view information.

Furthermore, the field of view information stored in the field of view information storage unit 203 is not limited to being a field of view angle for each viewer 400, and it may be a field of view angle range for each viewer 400, or may be an adjustment amount for each viewer 400 with respect to a predetermined basic field of view angle range. For example, the adjustment amount may be set to −10%, 0%, or +10% of the basic field of view angle range. Moreover, as described above, because the field of view angle is different for each viewer 400, it is preferable to apply a field of view angle to each viewer 400; however, a basic field of view angle may be applied, which is the field of view angle of a standard person. In this case, it is not necessary to include the field of view information storage unit 203, and, for example, the field of view angle of a standard person, namely an angle of 150 degrees in the vertical direction and 190 degrees in the horizontal direction is applied as the predetermined basic field of view angle. The display devices 1a, 1b, and 1c include the field of view information storage unit 203 inside the control units 20a, 20b, and 20c; however, it may be provided as a functional unit that is connected to the control units 20a, 20b, and 20c.

Moreover, in the display devices 1a, 1b, and 1c of the second to fourth example embodiments described above, the line of sight detection sensors 101, 101-1, 101-2, . . . , detect the respective lines of sight of both eyes of the viewer 400. The position detection sensors 102, 102-1, 102-2, . . . , also detect the respective positions of both eyes of the viewer 400. The control region calculation units 202, 202b, and 202c are configured to calculate the respective viewing regions of both eyes using the respective line of sight information and position information of both detected eyes and the field of view information of the viewer 400, and then calculate the viewing region 700 by combining the two calculated viewing regions. However, the configuration of the present invention is not limited to the configurations of the example embodiments. The viewing region 700 may be calculated using the line of sight information and position information of either one of the eyes of the viewer 400 and the field of view information of the viewer 400.

In addition, the position detection sensors 102, 102-1, 102-2, . . . , preferably detect the position of the eyes of the viewer. However, they may detect a position near the eyes, such as the position at the center of both eyes, or a position near the center of both eyes.

Also, in the third and fourth example embodiments, in the case of a configuration where the viewing region 700 is not considered and only processing that selects a narrower color gamut for the blind spot region 800 than the color gamut outside the blind spot region 800 is performed, detailed position information such as the position of the eyes of the viewer 400 or a position near the eyes is not necessary, and it is sufficient to know the position in which the viewer 400 is present. Consequently, the position detected by the position detection sensors 102, 102-1, 102-2, . . . , is not limited to the position of the eyes of the viewer 400 or a position near the position of the eyes. Even in such a case where the position of the eyes of the viewer 400 or a position near the eyes is not detected, the line of sight detection sensors 101, 101-1, 101-2, . . . , detect the line of sight of the viewer 400. Therefore, when the viewer 400 is not facing the direction of the display region, the detection units 10b and 10c do not transmit information to the control units 20b and 20c, and thus, the processing that selects a color gamut is not performed by the control units 20b and 20c.

Furthermore, in the third and fourth example embodiments described above, the display region of the display units 30b and 30c has a curved shape, and the blind spot region generated due to the curved shape is calculated. However, the configuration of the present invention is not limited to these example embodiments. Any shape may be used as long as it produces a blind spot; for example, a prismatic shape with a bottom surface having a polygonal shape when viewed from above may be used.

Moreover, the configuration of the first configuration example or the configuration of the second configuration example of the second example embodiment described above may be applied to the display devices 1b and 1c of the third and fourth example embodiments. Moreover, the configuration of the first configuration example of the third example embodiment may be applied to the display devices 1a and 1c of the second and fourth example embodiments.

In addition, the obstacle detection sensor 150 of the fourth example embodiment described above may be applied to the second and third example embodiments. As a result, when there is an obstacle in contact with the display region of the display unit 30a and 30b of the second and third example embodiments, the region that cannot be seen due to the obstacle becomes the blind spot region 800, which may display the image with a narrower color gamut than the display region other than the blind spot region 800.

Also, in the configuration of the second to fourth example embodiments described above, for example, if the line of sight position calculation units 201, 201b, and 201c repeatedly detect that the line of sight position is inside a predetermined fixed area for a predetermined fixed time or more, it can be concluded that the viewer 400 is gazing at the area. At this time, the image signal generation unit 205 may display the image in the viewing region 700 in a wider color gamut.

Furthermore, in the second to fourth example embodiments described above, it is possible to apply the following methods to the detection method of the line of sight of the viewer 400 performed by the line of sight detection sensors 101, 101-1, 101-2, . . . , in addition to the methods described above. That is to say, the line of sight detection sensors 101, 101-1, 101-2, . . . , may, for example, irradiate the viewer 400 with infrared rays emitted from an internally provided infrared LED. Then, a method may be applied in which the line of sight detection sensors 101, 101-1, 101-2, . . . , use a camera to capture and recognize the corneal reflection positions, which are caused by reflections of the infrared light by the corneas, and the irises, and use the position of the corneal reflections as reference points to detect the line of sight from the positional relationship with the irises.

Moreover, the line of sight detection sensors 101, 101-1, 101-2, . . . , may capture the image from which the line of sight is detected as a still image or a moving image. The detection frequency in which the line of sight of the viewer is detected from the captured image may be set arbitrarily; for example, the detection frequency may be set to once a second, such that a captured moving image is captured once a second and the line of sight is detected from the captured image. Alternatively, a still image may be captured once a second, and the line of sight may be detected from the captured still image. The detection frequency may be a fixed value or a variable value; for example, the detection frequency may be changed according to the image displayed by the display units 30a, 30b, and 30c.

In addition, in the second and fourth example embodiments described above, the detection units 10a and 10c are configured to include the line of sight detection sensor 101 and the position detection sensor 102; however, a single sensor unit may be provided that integrates these. In addition, in the third example embodiment described above, the detection unit 10b is configured to include the line of sight detection sensors 101-1, 101-2, . . . , and the position detection sensors 102-1, 102-2, . . . , corresponding to the line of sight detection sensors 101-1, 101-2, . . . , respectively; however, it may include a plurality of sensor units that integrate each of these. The integrated sensor units may include, for example, an internal video camera to detect the line of sight information and position information of the viewer 400 from the images captured by the video camera.

Also, in the second to fourth example embodiments described above, it is assumed that only one viewer 400 is present in the vicinity of the line of sight detection sensors 101, 101-1, 101-2, . . . , and that the each of the line of sight detection sensors 101, 101-1, 101-2, . . . , detect the line of sight of the one viewer 400; however, the configuration of the present example embodiment is not limited to these example embodiments. The line of sight detection sensors 101, 101-1, 101-2, . . . , may detect the line of sight of a plurality of viewers 400. When the line of sight detection sensors 101, 101-1, 101-2, . . . , detect the line of sight of a plurality of viewers 400, the viewing region 700 may be calculated using information about the line of sight and position of each viewer 400, or, based on the position information of the viewers 400 detected by the corresponding position detection sensors 102, 102-1, 102-2, . . . , the line of sight of the closest viewer 400 or the farthest viewer 400 may be selected, and the viewing region 700 of the selected viewer 400 may be calculated.

Moreover, in the second example embodiment, a single position detection sensor 102 is installed in a bezel provided near the center of the display device 1a and around the display unit 30a; however, a plurality of position detection sensors 102 may be installed in the bezel at several positions. With such an installation, the position of the viewer 400 can be detected with more detail.

In addition, in the third example embodiment, the four sensor units 100-1, 100-2, 100-3, and 100-4 are provided; however, the number of units is not limited to four, and may be more four or more. Further, by applying units having a wide detectable range, a configuration including three or two units is also possible. Also, a configuration provided with a single sensor unit that detects the line of sight information and position information of a plurality of viewers 400 in all directions is also possible.

Furthermore, the display units 30a, 30b, and 30c of the display devices 1a, 1b, and 1c of the second to fourth example embodiments have, for example, the configuration shown in FIG. 4 which includes a transmissive liquid crystal panel containing a backlight unit 320; however, a reflective liquid crystal panel may be applied to the display units 30a, 30b, and 30c. In the case of a reflective liquid crystal panel, it is not necessary to mount a backlight, and because the liquid crystal panel uses a dominant proportion of the power in the display panel, it is possible to achieve a further reduction in the power consumption. Also, a reflective liquid crystal panel may be provided with a front light that emits light according to the ambient illuminance. The illuminance of the front light allows the display panel to be viewed even in a dark environment.

Moreover, in the display units 30a, 30b, and 30c of the display devices 1a, 1b, and 1c of the second to fourth example embodiments, the display panel 300 is, for example, as shown in FIG. 4, a liquid crystal display (LCD) including a liquid crystal panel unit 310; however, a self-luminous display panel such as an OLED (Organic Light Emitting Diode) may be applied. In self-luminous display panels, it is known that the deterioration of the light-emitting element or TFT element accelerates when the temperature rises as a result of emitting light at a high brightness when displaying a wide color gamut; however, by applying the display devices 1a, 1b, and 1c of the second to fourth example embodiments and displaying a mixture of a wide color gamut display and a low color gamut display, it is possible to delay the deterioration of the light-emitting element or TFT element, and thereby, the reliability can be enhanced.

The display units 30a, 30b, and 30c of the display devices 1a, 1b, and 1c of the second to fourth example embodiments are configured by a direct view display; however, they may be configured by a projection type projector. In the case of a projection type projector, it is preferable for the line of sight detection sensors 101, 101-1, 101-2, . . . , and the position detection sensors 102, 102-1, 102-2, . . . , to be arranged near the projection surface on which the image is projected from the projector.

The display devices 1, 1a, 1b, and 1c of the example embodiments described above may be realized by a computer. In this case, a program for realizing the functions may be recorded in a computer-readable recording medium, and the functions may be realized by a computer system reading and executing the program recorded on the recording medium. The “computer system” referred to here includes an OS and hardware such as a peripheral device. Furthermore, the “computer-readable recording medium” refers to a portable medium such as a flexible disk, a magnetic optical disk, a ROM, or a CD-ROM, or a storage device such as a hard disk built into a computer system. In addition, the “computer-readable recording medium” may include those that dynamically retain the program for a short time, such as a communication line that transmits the program via a network such as the Internet or a communication line such as a telephone line, and those that retain the program for a fixed time, such as the volatile memory inside a computer system serving as a server or a client in this case. Furthermore, the program may be one capable of realizing some of the functions described above. Further, the functions described above may be realized in combination with a program already recorded in the computer system, and may be realized by using a programmable logic device such as an FPGA (Field Programmable Gate Array).

The example embodiments of the present invention have been described in detail above with reference to the drawings. However, specific configurations are in no way limited to the example embodiments, and include designs and the like within a scope not departing from the spirit of the present invention.

### INDUSTRIAL APPLICABILITY

The display device described above can be applied to a display that is required to have a large size, a high definition, a wide color gamut, as well as a reduced power consumption.

### REFERENCE SYMBOLS

1a Display device
10a Detection unit
20a Control unit
30a Display unit
101 Line of sight detection sensor
102 Position detection sensor
201 Line of sight position calculation unit
202 Control region calculation unit
203 Field of view information storage unit
204 Color gamut selection unit
205 Image signal generation unit
300 Display panel
310 Liquid crystal panel unit
320 Backlight unit

1. A display device comprising:
a display unit that displays an image;
a detection unit that detects a line of sight and a position of a viewer viewing the display unit; and
a control unit that selects, based on information about the position of the viewer detected by the detection unit, a color gamut according to a position of a display region of the display unit, and displays the image in the selected color gamut on the display unit.

2. The display device according to claim 1, wherein the control unit calculates a viewing region of the viewer in the display region of the display unit based on information about the line of sight and the position of the viewer detected by the detection unit, selects a wider color gamut for the calculated viewing region than a color gamut of the display region other than the viewing region, and displays the image in the selected color gamut on the display unit.

3. The display device according to claim 1, wherein the control unit calculates a blind spot region of the viewer in the display region of the display unit based on information about the position of the viewer detected by the detection unit and preliminary provided information about a shape of the display region of the display unit, selects a narrower color gamut for the calculated blind spot region than a color gamut of the display region other than the blind spot region, and displays the image in the selected color gamut on the display unit.

4. The display device according to claim 1,
wherein the detection unit detects a position of an obstacle that obstructs a display of the display unit, and
the control unit calculates a blind spot region of the viewer based on information about the position of the viewer detected by the detection unit and information about the position of the obstacle, selects a narrower color gamut for the calculated blind spot region than a color gamut of the display region other than the blind spot region, and displays the image in the selected color gamut on the display unit.

5. The display device according to claim 3, wherein the control unit calculates, a visible region, being the display region other than the blind spot region of the viewer, based on information about the position of the viewer detected by the detection unit, calculates a viewing region of the viewer included in the calculated visible region based on information about the line of sight of the viewer, selects a wider color gamut for the calculated viewing region than a color gamut of the display region other than the viewing region, and displays the image in the selected color gamut on the display unit.

6. The display device according to claim 5,
wherein the viewer includes a plurality of viewers, and
when the visible region is calculated for each of the viewers, the control unit merges the visible region for each of the viewers and subtracts the merged visible region from the display region to calculate the blind spot region.

7. The display device according to claim 2, further comprising:
a field of view information storage unit that stores in advance field of view information that indicates a field of view angle of the viewer,
wherein the control unit calculates the viewing region of the viewer on the display unit based on the information about the line of sight and the position of the viewer detected by the detection unit, and the field of view information corresponding to the viewer.

8. The display device according to claim 2,
wherein the display region of the display unit is configured by a plurality of display panels, the plurality of display panels including a first display panel at least portion of which is overlapped with the viewing region and a second display panel that is not overlapped with the viewing region, and
the control unit selects a wider color gamut for the first display panel than a color gamut of the second display panel, and displays the image in the selected color gamut on the display unit.

9. The display device according to claim 2, wherein when a specific display region, which is a portion of the display region, is specified in the display region of the display unit, the control unit selects a wider color gamut for the specific display region at least a portion of which is overlapped with the viewing region than a color gamut of the display region other than the specific display region, and displays the image in the selected color gamut on the display unit.

10. The display device according to claim 2, wherein the control unit, when displaying the image in the display region other than the viewing region, selects a color gamut to become a narrower color gamut as a distance from the viewing region increases, and displays the image in the selected color gamut on the display unit.

11. The display device according to claim 2, wherein the control unit displays the image on the display unit at a magnification according to a distance from the display region of the display unit to the viewer.

12. A display method for a device including a display unit that displays an image, comprising:
detecting a line of sight and a position of a viewer viewing the display unit;
selecting, based on information about the detected position of the viewer, a color gamut according to a position of a display region of the display unit; and
displaying the image in the selected color gamut on the display unit.
